(19) United States
(12) Patent Application Publication
(10) Pub. No.: US 2021/0165346 A1
(43) Pub. Date: Jun. 3, 2021

(54) REFILL DISPENSER FOR REFILLING DEVELOPER CARTRIDGE

(71) Applicant: HEWLETT-PACKARD DEVELOPMENT COMPANY, L.P., Spring, TX (US)

(72) Inventors: Matthew Storey, Austin, TX (US); Corbett Benjamin Schoenfelt, US, TX (US); Bennett Alexander Nadeau, Austin, TX (US); Zackary Thomas Hickman, Austin, TX (US); Jefferson Blake West, Austin, TX (US); Muriel Hale Shields, Austin, TX (US)

(21) Appl. No.: 17/262,888

(22) PCT Filed: Jan. 24, 2019
(86) PCT No.: PCT/US2019/014891

§ 371 Date: Jan. 25, 2021

(51) Int. Cl. G03G 15/08; B65D 83/00

(52) U.S. Cl. CPC G03G 15/0894; B65D 83/0077; B65D 83/0072; G03G 15/0865

(57) ABSTRACT

A refill dispenser for providing developer to a developer cartridge of an image forming apparatus is provided. The refill dispenser includes a container having a first section to accommodate developer and a second section including a source of pressure applied to the first section, a movable diaphragm interposed between the first section and the second section, and a valve coupled to the first section, wherein the pressure applied from the second section causes developer in the first section to be removed upon an opening of the valve

### BACKGROUND

An image forming apparatus uses a developer such as ink or toner to print an image on a recording medium such as paper. Since the ink or toner is used every time an image forming operation proceeds, the ink or toner is exhausted after a predetermined number of operations. In that case, a component storing the ink or toner may be replaced or refilled with ink or toner. In considering whether to replace or refill the component, issues such as convenience and costs may be considered. For example, when considering whether to replace or refill a cartridge containing toner, the cost of the cartridge and the ease with which the cartridge is refilled with toner may be considered.

### BRIEF DESCRIPTION OF DRAWINGS

Certain examples of the present disclosure will be more apparent from the following description taken in conjunction with the accompanying drawings, in which:

FIG. 1 is a view illustrating an image forming apparatus, according to an example;

FIG. 2 is a block diagram illustrating a configuration of an image forming apparatus, according to an example;

FIG. 3 is a block diagram illustrating a more specific configuration of an image forming apparatus, according to an example;

FIG. 4 is a view illustrating a printing engine, according to an example;

FIG. 5 is a view illustrating a developer refill dispenser, according to an example;

FIG. 6 is a view illustrating a more specific configuration of a developer refill dispenser, according to an example; and

FIG. 7 is a view illustrating a more specific configuration of a refill dispenser, according to another example.

Throughout the drawings, it should be noted that like reference numbers are used to depict the same or similar elements, features, parts, components, and structures. It should also be noted that the figures are not necessarily to scale, and the size of some parts may be exaggerated to more clearly illustrate the example shown.

### DETAILED DESCRIPTION OF EXAMPLES

Various examples now will be described more fully hereinafter with reference to the accompanying drawings. The examples described hereinafter may be modified in many different forms. To more clearly describe features of examples, matters well known to one of ordinary skill in the art to which the below examples pertain will not be described in detail.

Throughout the description, when an element is referred to as being “connected” or “coupled” to another element, it can be directly connected or coupled to the other element, or can be connected or coupled to the other element with one or more intervening element interposed therebetween.

In the following description, a singular expression includes a plural expression, unless otherwise specified. It is also to be understood that terms such as “comprises” or “includes” are used herein to designate a presence of a characteristic, a number, a step, an operation, an element, a component, or a combination thereof, and not to preclude the presence or the possibility of adding one or more of other characteristics, numbers, steps, operations, elements, components, or a combination thereof.

The term “image forming apparatus” refers to any device that is able to print data that is generated by a terminal device such as a computer on a recording medium such as paper. Examples of an image forming apparatus include a copier, a printer, a scanner, a facsimile, or a multi-function peripheral (MFP) that combines two or more functions of the copier, the printer, the scanner, or the facsimile through a single device.

The term “image forming job” as used herein may mean any of various jobs or processes related to an image (e.g., printing, copying, scanning, or faxing), such as forming an image or generating/storing/transmitting an image file, and “job” may mean not only an image forming operation but also a series of processes which are necessary for performing an image forming operation.

The term “user” may mean a person who performs an operation related to an image forming operation using an image forming apparatus or a device connected with an image forming apparatus by wire or wirelessly. The term “administrator” may mean a person who has authority to access all the functions and systems of the image forming apparatus. The “administrator” and the “user” may be the same person.

An image forming apparatus uses a developer such as ink, toner, or the like to print an image on a recording medium such as paper. To provide the developer during an image forming job, a cartridge is provided within the image forming apparatus, the cartridge having the developer therein. Because the developer is supplied from the cartridge for each image forming job and because the amount of developer included in the cartridge is limited, the developer is exhausted after a predetermined number of image forming jobs. In that case, rather than replace the cartridge, it may be desired to refill the cartridge with developer as refilling the cartridge may be a lower cost alternative to replacing the cartridge. Further, refilling the cartridge may be a quicker, easier, and cleaner process for a user as opposed to replacing the cartridge and thus reduce the amount of time or effort as compared with that needed for replacing the cartridge. Accordingly, a dispenser or canister for refilling a developer cartridge may be provided.

In the following description, the terms “developer,” “ink,” “toner,” or the like may be used interchangeably in reference to a developing agent used for image processing.

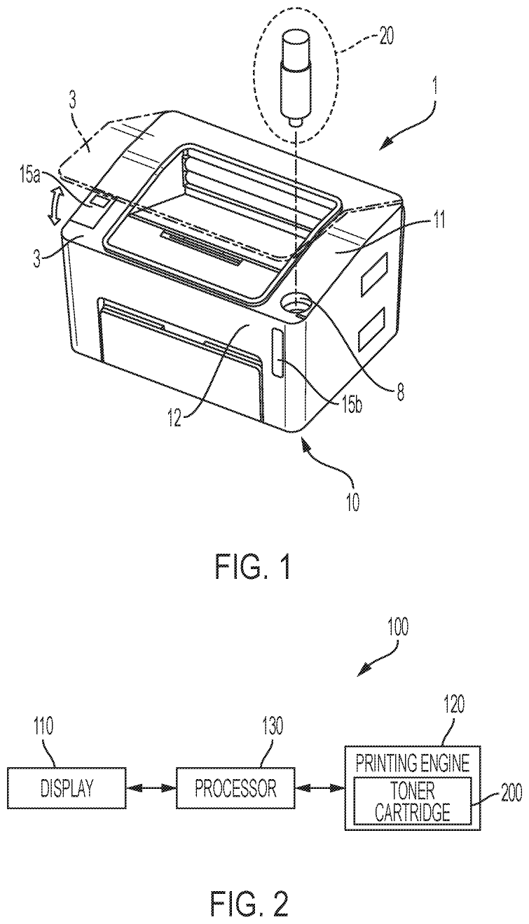

FIG. 1 illustrates an image forming apparatus that may be coupled to a refill dispenser for providing toner to a toner cartridge of the image forming apparatus, according to an example.

Referring to FIG. 1, an image forming apparatus 10 may include a main body 1 and a developer cartridge (not shown) that is removable from the main body 1. The image forming apparatus 10 may further include one or more display that may provide information to a user. For example, the image forming apparatus 10 may include a first display 15a to provide information regarding a status of the image forming apparatus 10 such as an amount of remaining paper, an error state of the image forming apparatus 10, or the like, and may include a second display 15b to provide information regarding an amount of remaining developer. In another example, the image forming apparatus 10 may include a single display to provide information such as an amount of remaining developer, an amount of remaining paper, an error state of the image forming apparatus 10, or the like.

The main body 1 may be provided with a door 3 and the door 3 may open and close a portion of the main body 1. In the example of FIG. 1, the door 3 is illustrated for opening an upper portion of the main body 1. However, this is merely an example and a door for opening a side or the whole of the main body 1 may be employed if necessary. The developer cartridge may be mounted in the main body 1 or removed from the main body 1.

The main body 1 may be provided with a coupling portion 8 such that a developer refill dispenser 20 may be coupled to the main body 1. The coupling portion 8 may be provided on an upper surface 11 of the main body 1 such that the developer refill dispenser 20 may be coupled to the upper surface 11 through the coupling portion 8. The coupling portion 8 may be coupled with the developer cartridge to provide a path through which toner from the developer refill dispenser 20 may be provided to the cartridge. In an example, the coupling portion 8 may be provided at a position close to a front portion 12 of the main body 1. However, the coupling portion 8 may be located at other positions of the main body 1.

FIG. 2 is a block diagram illustrating a configuration of an image forming apparatus, according to an example.

Referring to FIG. 2, an image forming apparatus 100 may include a display 110, a printing engine 120, and a processor 130.

The display 110 may display various kinds of information provided by the image forming apparatus 100. For example, the display 110 may display information on an amount of remaining paper, an error state of the image forming apparatus 10, an amount of toner in a toner cartridge 200 in the image forming apparatus 100, or the like. Further, the display 110 may indicate that the toner in the toner cartridge 200 needs to be refilled when the toner is below a preset amount.

The printing engine 120 may form an image. For example, the printing engine 120 may perform printing using toner contained in the toner cartridge 200. The printing engine 120 may include various consumable devices which are directly or indirectly involved in an image forming job. For example, in the case of a laser image forming apparatus, a charging device, an exposure device, a developing device, a transferring device, a fixing device, various rollers, a belt, an organic photo conductor (OPC) drum, and the like can be consumable devices. In addition, various types of devices requiring replacement, such as a developing device, may be defined as a consumable device. One of such consumable devices is a toner cartridge, and the toner cartridge can perform the function as the developing device as described above. An example configuration and operation of a printing engine will be described later with reference to FIG. 4.

The toner cartridge 200 provides toner to a developing device and toner in the toner cartridge 200 can be refilled by a developer refill dispenser, such as the developer refill dispenser 20 of FIG. 1.

The processor 130 may control components in the image forming apparatus 100. For example, the processor 130, when receiving print data from a printing control terminal device (not shown), may control the printing engine 120 so that the received print data is printed, or the like. Here, the printing control terminal device may be an electronic device which provides the printing data and may be a personal computer (PC), a notebook, a tablet PC, a smartphone, a server, and the like.

The processor 130 may be configured as a single device such as a central processing unit (CPU), or may be configured as a plurality of devices such as a clock generation circuit, a CPU, and a graphic processor.

The processor 130 may determine an amount of toner in the toner cartridge 200 and control the display 110 so that the determined toner amount is displayed. In an example, the processor 130 may control the display 110 to illuminate a light-emitting area corresponding to the amount of toner.

In an example, when the image forming apparatus 100 is capable of performing color printing, the printing engine 120 may include a plurality of toner cartridges of different toner colors. For example, a toner cartridge for each of a cyan/magenta/yellow/black color may be included. In this way, when the printing engine 120 has a plurality of toner cartridges, the processor 130 may control the display 110 to display a toner amount of each of the plurality of toner cartridges. Furthermore, if a toner cartridge for each of the cyan/magenta/yellow/black colors is included, the image forming apparatus may be provided with a corresponding coupling portion (such as coupling portion 8 of FIG. 1) for each toner cartridge.

The processor 130, when displaying a toner amount of each of the aforementioned plurality of toner cartridges, may control the display 110 so that the light-emitting area and the background area have a color corresponding to the toner color of the toner cartridge 200 which is currently displayed. Accordingly, a user may intuitively see colors that are displayed on the display 110 and recognize an amount of toner for a corresponding toner cartridge.

When the user connects a developer refilling device, such as the developer refill dispenser 20 of FIG. 1, to the image forming apparatus 100, the processor 130 may determine whether the connected developer refilling device is usable (e.g., genuine, authorized, etc.). In an example, the processor 130 may not only confirm whether the connected developer refilling device is a genuine device or a device having a usage history, but may also determine whether a developer (e.g., toner) color of the developer refilling device and a toner color of the toner cartridge 200 that needs to be refilled coincide with each other.

The processor 130 may control the toner cartridge 200 so that the developer (e.g., toner) in the developer refilling device is injected into the toner cartridge 200 if it is confirmed that the developer refilling device is usable. Here, the toner cartridge 200 may include a hole through which the toner can be injected and a locking member that electrically opens and closes the hole. Further, the toner cartridge 200 may be coupled with a coupling portion (such as coupling portion 8 of FIG. 1) for receiving the toner from a developer refilling device coupled to the image forming apparatus 100 using the coupling portion.

When the toner in the toner cartridge 200 is refilled using the developer refilling device, the processor 130 may control the display 110 to indicate the status of the toner cartridge 200, such as that the toner cartridge 200 has been filled.

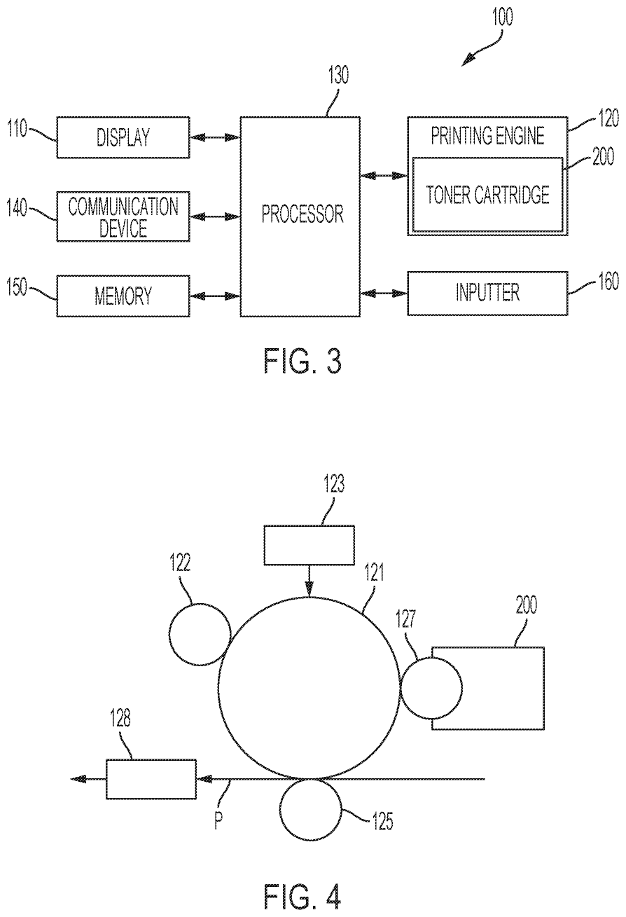

An example of an image forming apparatus has been described. However, various configurations may be added additionally. Examples of such various configurations will be described with reference to FIG. 3.

FIG. 3 is a block diagram illustrating a more specific configuration of an image forming apparatus, according to an example.

Referring to FIG. 3, the image forming apparatus 100 may include the display 110, the printing engine 120, the processor 130, a communication device 140, a memory 150, and an inputter 160.

The display 110 and the printing engine 120 have been described with reference to FIG. 2, and a redundant description will be omitted. The processor 130 has been described with reference to FIG. 2 and thus, the contents described in FIG. 2 are not again described but only the contents related to the configuration added in FIG. 3 will be described below.

The communication device 140 may be connected to a print control terminal device (not shown), and can receive print data from the print control terminal device. In an example, the communication device 140 is formed to connect the image forming apparatus 100 to an external device, and may be connected to the external device (e.g., a print control terminal device) via a local area network (LAN) or the Internet network, a universal serial bus (USB) port or a wireless communication (e.g., WiFi 802.11a/b/g/n, NFC, Bluetooth, etc.) port. Such a communication device 140 may be referred to as a transceiver.

The communication device 140 may communicate with a developer refilling device, such as a developer refill dispenser 20 of FIG. 1. In an example, when the developer refilling device is connected to one or more of the toner cartridge 200, a toner box (not shown), a toner container (not shown), or the developing device (not shown), the communication device 140 may communicate with the developer refilling device.

If it is determined that the amount of toner in the toner cartridge 200 is less than or equal to a predetermined amount and the toner cartridge 200 needs to be replaced or refilled, the communication device 140 may transmit information about the toner cartridge 200 to a management server (not shown) or an administrator (e.g., the terminal device of the administrator). In addition, the processor 130 may perform communication with the developer refilling device using the communication device 140. The processor 130 may perform an authentication procedure to determine whether the developer refilling device is a legitimate device based on information provided from the toner refiling device.

The memory 150 may store print data received through the communication device 140. The memory 150 may store history information of a printing job which is performed by the image forming apparatus 100.

The memory 150 may store information regarding a toner refill history of the toner cartridge 200. The memory 150 may be implemented as a storage medium in the image forming apparatus 100, or an external storage medium, for example, a removable disk including a USB memory, a web server through a network, or the like.

The memory 150 may be composed of a plurality of memory elements. For example, the memory may include a first memory for storing data necessary for the operation of the image forming apparatus and a second memory for storing information related to a customer replaceable unit monitor (CRUM) device (not shown) or a toner refilling device. In an example, the second memory may be a non-transitory memory such as an Electrically Erasable Programmable Read-Only Memory (EEPROM).

The inputter 160 may receive a control command to select a function from a user. For example, the function may include a printing function, a copying function, a scanning function, a fax transmission function, etc. The inputter 160 may be implemented as one or more touch keys, a touch screen, or the like. If implemented as a touch screen, functions of the display 110 may be performed by the inputter 160.

As described above, a user of the image forming apparatus 100 may refill the toner cartridge 200 without replacing the toner cartridge 200. In addition, the image forming apparatus 100 may indicate the amount of toner in the toner cartridge 200 through the display 110, so that the user can intuitively determine the amount of toner and more easily determine whether the toner needs to be refilled.

FIG. 4 is a view illustrating a printing engine, according to an example.

Referring to FIG. 4, a printing engine may include a photosensitive drum 121, a charger 122, an exposure device 123, a developing device 200, a transfer device 125, and a fixing device 128.

An electrostatic latent image is formed on the photosensitive drum 121. The photosensitive drum 121 may be referred to as a photosensitive drum, a photosensitive belt, or the like depending on its form.

The charger 122 charges the surface of the photosensitive drum 121 to a uniform potential. The charger 122 may be implemented in the form of a corona charger, a charging roller, a charging brush, or the like.

The exposure device 123 changes the surface potential of the photosensitive drum 121 according to the image information to be printed, thereby forming an electrostatic latent image on the surface of the photosensitive drum 121

The developing device 200 (e.g., toner cartridge) accommodates a developer therein, and supplies the developer to the electrostatic latent image to develop the electrostatic latent image into a visible image. In various examples, the developer may be referred to as ink, toner, or the like and the use of one term versus another is not intended to limit application, use, or applicability of the developing device 200 or a developer refilling device (e.g., developer refill dispenser 20 of FIG. 1) The developing device 200 may include a developing roller 127 for supplying the developer to the electrostatic latent image.

The visible image formed on the photosensitive drum 121 is transferred to a recording medium P by the transfer device 125 or an intermediary transfer belt (not shown).

The fixing device 128 fixes the visible image on the recording medium P by applying heat and/or pressure to the visible image on the recording medium P. The printing operation is completed by this series of processes.

The developer contained in the aforementioned developing device 200 is used whenever an image forming job is performed. Thus, it is exhausted if more than a predetermined number of image forming jobs are performed. In that case, it may be desired to refill the developer (e.g., toner) using a developer refill dispenser, thus eliminating the need to replace the developing device 200 (e.g., toner cartridge).

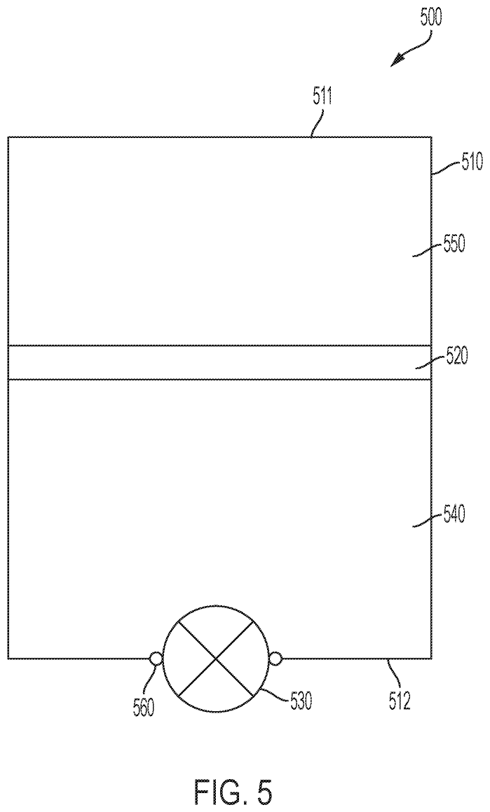

FIG. 5 is a view illustrating a developer refill dispenser, according to an example.

Referring to FIG. 5, a developer refill dispenser 500 may include a container 510, a diaphragm 520, and a valve 530. The diaphragm 520 may be movably coupled to the container 510 to establish a first section 540 and a second section 550 by being interposed therebetween. Though not shown, the first section 540 may include developer (e.g., ink, toner, etc.) therein. The second section 550 provides a pressure greater than an atmospheric pressure on a first or top surface the diaphragm 520. A second or bottom surface of the diaphragm 520 is exposed to the first section 540 such that the pressure from the second section 550 is applied on the first section 540. Based on the applied pressure from the second section 550, developer included in the first section 540 may be removed from the first section 540 through the valve 530 upon an opening of the valve 530.

The container 510 may have any of various shapes to provide a desired configuration and/or volume of the refill dispenser 500. For example, the container 510 may be shaped as one or more of a sphere, a cylinder, a cone, a cube, a tetrahedron, another three-dimensional (3D) shape, or a combination of 3D shapes to provide a desired configuration and/or volume. The container 510 may have a top surface 511 and a bottom surface 512. To couple the valve 530 to the container 510, the bottom surface 512 may include an opening in which the valve 530 is located. Further, a seal 560 may be provided between the bottom surface 512 and the valve 530 to couple the valve 530 to the container 510. Still further, the bottom surface 512 may include a flange or other orifice (not shown) extending away from the container 510 to provide a mechanical coupling to an image forming apparatus. For example, the bottom surface 512 may include a flange for coupling to a coupling portion of an image forming apparatus. In another example, the valve 530 may be provided with a flange or orifice for coupling to an image forming apparatus such as to a coupling portion of an image forming apparatus.

In an example, the bottom surface 512 of the container 510 may have a conical shape. In that case, the valve 530 may be coupled to an opening in the conical shaped bottom surface 512 and the seal 560 may be provided between the opening and the valve 530. In another example, the bottom surface 512 may have a flat shape while the valve 530 may have a conical shape. In that case, the seal 560 may again be provided between the valve 530 and an opening in the bottom surface 512 of the container 510. In other examples, the bottom surface 512 may be shaped as a sphere, a tetrahedron, a pyramid, a combination of 3D shapes, or the like.

The source of pressure provided by the second section 550 may be achieved by at least one of a spring or an ambient pressure that is greater than an atmospheric pressure. Upon an opening of the valve 530, the pressure provided by the second section 550 is exerted by the diaphragm 520 to the first section 540 such that developer contained in the first section 540 is forced through the valve 530. In that case, when the developer refill dispenser 500 is coupled to an image forming apparatus, such as by a coupling portion 8 of the image forming apparatus 10 of FIG. 1, the developer contained in the first section 540 is provided to a developer cartridge located within the image forming apparatus through the coupling portion.

In various examples, the volume and shape of the container 510 as well as the pressure applied by the second section 550 may be changed to address different needs of a user. For example, a volume of the first section 540 of the container 510 may be designed corresponding to an amount of developer that is desired to be provided to a developing cartridge of an image forming apparatus. As another example, the pressure applied by the second section 550 may similarly be designed corresponding to the amount of developer that is to be provided upon an opening of the valve 530 without asserting unnecessary pressure on the diaphragm 520 or the first section 540 prior to the opening of the valve 530.

For example, to avoid compacting of developer contained in the first section 540 prior to the opening of the valve 530, it is desired to minimize or prevent movement of the diaphragm 520 while maintaining the pressure from the second section 550. Thus, the coupling of the diaphragm 520 to the container 510, the seal 560, the valve 530, and the top surface 511 are provided to minimize or prevent a reduction of pressure of the second section 550. For example, the coupling of the diaphragm 520 to the container 510 is provided to minimize a leakage of air and/or developer from the first section 540 to the second section 550 and to minimize a movement of the diaphragm 520 before the valve 530 is opened.

Similarly, the valve 530 and the seal 560 are provided to minimize or prevent a leakage of air and/or developer from the first section 540 prior an opening of the valve 530. The top surface 511 is provided to maintain the pressure applied from the second section 550 to the diaphragm 520. In various examples, the top surface 511 may be provided to reduce or prevent air leakage from the second section 550 through the top surface 511 or through a coupling of the top surface 511 to the container 510, or may be provided to maintain a spring pressure applied against the diaphragm 520.

Although not shown, the top surface 511 may include an opening to allow for applying the pressure to the first section 540. For example, the top surface 511 may include an opening such as a valve through which a compressed gas such as air may be provided to the first section 540. Further, the top surface 511 may be removable from the container 510. In that case, a flange or other connection may be provided on each of the top surface 511 and the container 510 to accommodate removal of the top surface 511 from the container 510. As an example, the flanges of the top surface 511 and the container 510 may be secured using a stud, a bolt, or another mechanical fastener. Further, a gasket or other seal may be provided between the container 510 and the top surface 511 to prevent or minimize a reduction in the pressure provided by the second section 550.

The diaphragm 520 may be coupled with the container 510 to reduce or prevent a reduction in the pressure of the second section 550 while the valve 530 remains closed. For example, the diaphragm 520 may be coupled to the container 510 to reduce or otherwise prevent the leakage of air and/or developer from the first section 540 to the second section 550. In that regard, the container 510 may include a first dimension such as a first cross-section that corresponds to a second dimension such as a second cross-section of the diaphragm 520. As an example, if the container 510 is implemented having a cylindric section in which the diaphragm 520 is located, an outer diameter of the diaphragm 520 may correspond to an inner diameter of the cylindric section of the container 510.

Similarly, the valve 530 may be coupled to the container 510 to reduce or otherwise prevent the leakage of air and/or developer from the first section 540 through the coupling of the valve 530 to the container 510. Moreover, in the closed position, the valve 530 is provided to reduce or otherwise prevent the leakage of air and/or developer from the first section 540 through the valve 530.

In an example, the valve 530 provides on/off flow of developer from first section 540 through the valve 530. Examples of the valve 530 may include a ball valve, a gate valve, a knife valve, a plunger valve, or the like.

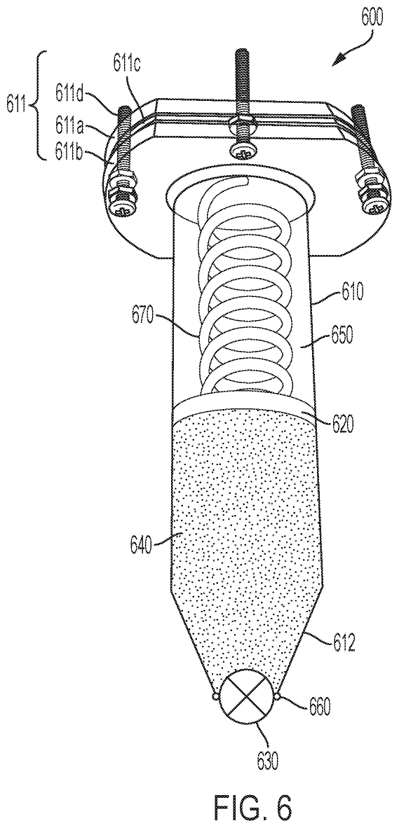

FIG. 6 is a view illustrating a more specific configuration of a developer refill dispenser, according to an example.

Referring to FIG. 6, a developer refill dispenser 600 includes a container 610, a diaphragm 620, and a valve 630. The diaphragm 620 movably separates the container 610 into a first section 640 and a second section 650. The first section 640 includes a developer (e.g., toner) therein and the second section 650 provides a pressure on the diaphragm 620.

The container 610 includes a top surface 611. In the example of FIG. 6, the top surface 611 includes a cover 611a, a flange 611b, a seal 611c, and a mechanical fastener 611d. The cover 611a, the flange 611b, the seal 611c, and the mechanical fastener 611d are provided so the top surface 611 may be removable from the container 610. For example, the seal 611c may include a gasket and the mechanical fastener 611d may include a bolt, a stud, or the like that couples with the flange 611b to secure the top surface 611 to the container 610. In another example in which it is not necessary for the top surface 611 to be removable, the seal 611c may include an adhesive material to seal and mechanically couple the cover 611a to the flange 611b such that the mechanical fastener 611d may not be necessary and may be selectively removed. In yet another example, the top surface 611 may include a cover 611a provided as a cap having a threaded surface and a flange 611b also having a threaded surface. In that example, the threaded surfaces of the cover 611a and the flange 611b may engage as the cover 611a is rotated against the flange 611b. Further, the seal 611c may be provided as a gasket between the threaded cover 611a and the threaded flange 611b.

In the example of FIG. 6, a bottom surface 612 of the container 610 has a conical shape with an opening. The opening of the bottom surface 612 is provided to receive the valve 630 and a seal 660 is provided between the bottom surface 612 and the valve 630. The valve may include a ball valve, a gate valve, a knife valve, a plunger valve, or the like. Furthermore, although the bottom surface 612 is illustrated as having a conical shape with an opening to receive the valve 630, in another example, the bottom surface 612 may be flat while a body of the valve 630 has a conical shape. In that example, the seal 660 would again be provided between the opening of the bottom surface 612 and the body of the valve 630.

In the example of FIG. 6, the pressure applied by the second section 650 is provided by a spring 670. In various examples, the spring 670 may include a helical compression spring, a conical compression spring, a bow spring, a diaphragm, or the like. The spring 670 may have a first end coupled to the diagraph 620 and a second end coupled to the top surface 611.

The diaphragm 620 is movably coupled to the container 610 such that, upon an opening of the valve 630, the pressure applied by the spring 670 to the diaphragm 620 causes the developer in the first section 640 to be moved through the valve 630. In the example of FIG. 6, the container 610 is illustrated as having a cylindric form. In that example, an outer diameter of the diaphragm 620 is provided to couple to an inner diameter of the container 610 to minimize or prevent a leakage of air and/or developer from the first section 640 past the diaphragm 620. The diaphragm 620 may include a rubber or other elastic material that is movable against the container 610 while minimizing or preventing leakage of air and/or developer from the first section 640 into the second section 650. Further, a top or first surface of the diaphragm 620 and a bottom or second surface of the diaphragm 620 may include a rigid material to maintain a shape of the diaphragm 620 during its movement. In another example, the diaphragm 620 may include a sufficiently rigid material having an outer diameter that provides a seal during movement within the container 610.

A size and pressure of the spring 670 may be selected based on a volume of the first section 640, a distance between the top surface 611 and the diaphragm 620, a volume of developer to be provided from the first section 640, or the like. Furthermore, although only a single spring 670 is illustrated in FIG. 6, two or more springs 670 may be provided.

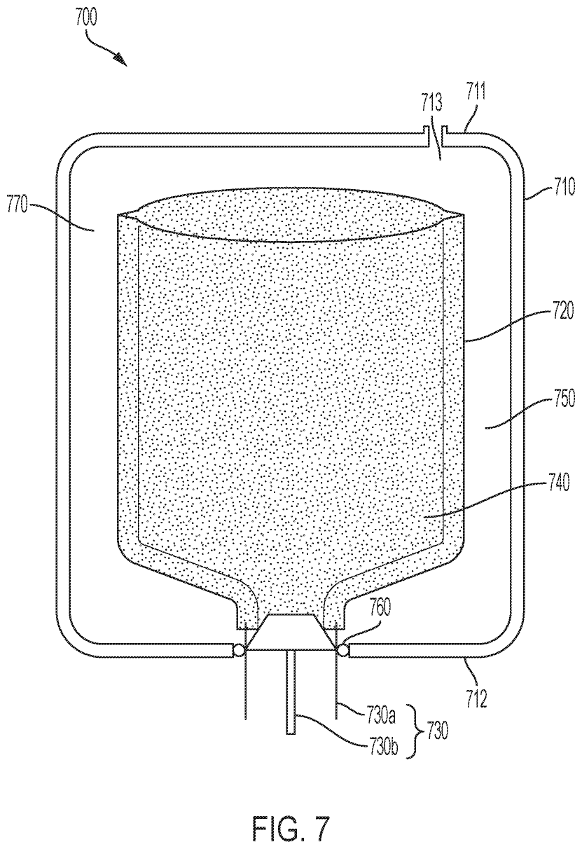

FIG. 7 is a view illustrating a more specific configuration of a developer refill dispenser, according to another example.

Referring to FIG. 7, a developer refill dispenser 700 may include a container 710, a diaphragm 720, and a valve 730. In the example of FIG. 7, the diaphragm 720 is provided as a deformable bag within the container 710. A developer such as toner is provided in a first section 740, which is within the deformable bag. A second section 750 is provided as an exterior of the deformable bag within the container 710. The second section 750 provides a pressure 770 against the diaphragm 720 using a gas such as air at a pressure greater than an atmospheric pressure.

In the example of FIG. 7, a top surface 711 of the container 710 includes a valve 713. The valve 713 allows for compressed gas (e.g., air, etc.) to be introduced into the second section 750 to provide the pressure 770.

A bottom 712 of the container 710 includes an opening in which the valve 730 may be located. A seal 760 is provided between the opening of the bottom surface 712 and the valve 730. In the example of FIG. 7, the valve 730 includes an orifice 730a and a plunger 730b. The orifice 730a provides a discharge path for developer when the valve 730 is opened and may provide a coupling mechanism when the developer refill dispenser 700 is coupled to an image forming apparatus. In another example, the bottom surface 712 may include a flange (not illustrated) surrounding the opening to provide a coupling to an image forming apparatus during a developer refill operation. Also, the orifice 730a is sealed or otherwise coupled to the diaphragm 720 to prevent the leakage of air and/or developer from the first section 740 into the second section 750.

The valve 730 also includes the plunger 730b. During an opening operation of the valve 730, the plunger 730b may be moved into the first section 740, which may assist in aerating developer that is moved past the plunger 730b as the developer is expelled through the valve 730. In other examples, the valve 730 may be implemented as any of a ball valve, a gate valve, a knife valve, or the like. In any of these examples, the valve 730 may be provided with the orifice 730a which may be used for coupling with an image forming apparatus.

The amount of pressure 770 provided in the second section 750 may be selected based on various factors such as an amount of developer desired be expelled from the first section 740 through the valve 730, a volume of air and developer in the first section 740, a comparative size of a volume of the first section 740 to a volume of the container 710, a size of the opening of the valve 730, or the like.

In implementation, when a user couples the developer refill dispenser 700 to an image forming apparatus to refill a developer cartridge, such as the developer cartridge 200 of FIG. 2, the valve 730 may be opened by a user's manipulation or may be automatically opened based on the coupling. Upon an opening of the valve 730, the pressure 770 of the second section 750 causes developer in the first section 740 to be expelled through the opened valve 730. Furthermore, deformation of the diaphragm 720 may assist in aerating the developer as it is expelled through the valve 730, which in turn reduces packing of the developer.

Although the examples have been described with reference to the accompanying drawings, those of ordinary skill in the art will understand that various changes and modifications may be made therein. For example, the relevant results may be achieved even when the described components such as systems, structures, and devices are coupled or combined in a different form than those described above or are replaced or substituted by other components or equivalents.

Therefore, the scope of the present disclosure should be defined not by the described examples alone, but by the appended claims and the equivalents thereof.

What is claimed is:

1. A refill dispenser for providing developer to a developer cartridge of an image forming apparatus, the refill dispenser comprising:
a container comprising a first section to accommodate developer and a second section including a source of pressure applied to the first section;
a movable diaphragm interposed between the first section and the second section; and
a valve coupled to the first section,
wherein the pressure applied from the second section causes developer in the first section to be removed upon an opening of the valve.

2. The refill dispenser of claim 1, wherein the valve comprises a plunger valve that moves into the first section upon the opening of the valve.

3. The refill dispenser of claim 1, wherein the source of pressure comprises a spring for applying the pressure to the first section.

4. The refill dispenser of claim 3,
wherein the container comprises a first cross-section,
wherein the diaphragm comprises a first surface and a second surface opposite to the first surface, a second cross-section of the diaphragm corresponding to the first cross-section of the container to provide a seal with the container, and
wherein the developer contacts the second surface of the diaphragm and the spring contacts the first surface of the diaphragm to move the diaphragm upon the opening of the valve.

5. The refill dispenser of claim 4, wherein the spring comprises at least one of helical compression spring, a conical compression spring, or a bow spring.

6. The refill dispenser of claim 1, wherein the source of pressure comprises an air pressure in the second section that is greater than an atmospheric pressure.

7. The refill dispenser of claim 6, wherein the air pressure in the second section increases corresponding to a decrease in a volume of the second section.

8. A refill dispenser for providing developer to a developer cartridge of an image forming apparatus, the refill dispenser comprising:
a container having a first end, a second end, and a first cross-section;
a diaphragm, having a top surface and a bottom surface, positioned to move within the container between the first end and the second end, the diaphragm having a second cross-section corresponding to the first cross-section of the container to create a seal;
a spring positioned between the top surface of the diaphragm and the second end of the container; and
a valve coupled to the first end of the container,
wherein, a space between the bottom surface of the diaphragm and the first end of the container accommodates developer that is removed upon an opening of the valve due to a force of the spring.

9. The refill dispenser of claim 8, wherein the spring comprises at least one of helical compression spring, a conical compression spring, or a bow spring.

10. The refill dispenser of claim 8, wherein the first end of the container, the second end of the container, and the valve are sealed to prevent air leakage.

11. The refill dispenser of claim 8, wherein the valve comprises a plunger valve that moves into the container upon the opening of the valve.

12. A refill dispenser for providing developer to a developer cartridge of an image forming apparatus, the refill dispenser comprising:
a chamber including an opening;
a valve coupled with the opening of the chamber; and
a deformable bag, located within the chamber and coupled with an inlet of the valve, the deformable bag including developer therein,
wherein a pressure within the chamber causes the developer to be removed from the developer bag through the valve upon an opening of the valve.

13. The refill dispenser of claim 12, wherein the pressure within the chamber varies corresponding to a volume of the chamber relative to a volume of the deformable bag.

14. The refill dispenser of claim 12, wherein the valve comprises a plunger valve that moves into the deformable bag upon the opening of the valve.

15. The refill dispenser of claim 12, wherein the coupling of the valve to the opening of the chamber and the coupling of the deformable bag to the inlet of the valve prevent a leakage of air.
